(19) United States
(12) Patent Application Publication
(10) Pub. No.: US 2016/0023343 A1
(43) Pub. Date: Jan. 28, 2016

(54) Spring biased lever for opening a moveable member of an adapter for a flooring nail gun

(71) Applicant: TAIZHOU DAJIANG INDUSTRY CO., LTD., Taizhou City, Zhejiang (CN)

(72) Inventors: Mingjun Yang, Taizhou City, Zhejiang (CN); Zaijun Zhu, Taizhou City, Jhejiang (CN); Qinling Ying, Taizhou City, Jhejiang (CN)

(21) Appl. No.: 14/363,812

(22) PCT Filed: May 14, 2013
(86) PCT No.: PCT/CN2013/075583

§ 371 Date: Jun. 9, 2014

(30) Foreign Application Priority Data
Apr. 16, 2013 (CN) 201310132702.0

(51) Int. Cl. B25C 7/00

(52) U.S. Cl. CPC B25C 7/00

(57) ABSTRACT

An adapter for a flooring nail gun is provided with a muzzle member including at least one set of two inclined cavities; a moveable member including at least one set of two inclined protrusions at an end, the inclined protrusions being disposed in the inclined cavities; and a quick releasing device disposed on the inclined protrusions. The quick releasing device includes a pressing member, a spring member, and a lever, and wherein the pressing member and the muzzle member are joined, the lever and the pressing member are pivotably secured together, and the spring member has one end anchored at the pressing member and the other end pivotably secured to the lever. The moveable member can be opened for troubleshooting in case of malfunction.

| | | | |
|---|---|---|---|
| Priority Data: | 201310132702.0 | 2013 Apr. 16 | CN |

### BACKGROUND OF THE INVENTION

1. Field of the Invention

The invention relates to wood flooring installation devices and more particularly to a spring biased lever capable of opening a moveable member of an adapter for a flooring nail gun in case of malfunction.

2. Description of Related Art

Flooring nail guns are widely used for wood flooring installation. A launched nail is required to overcome resistance from a wood strip and a subfloor in order to fasten them together in use. The resistance is especially greater when the nail is about to reach its desired position. A vertical fraction of the driving force of the nail can displace a moveable member, resulting in failure of nailing. Typically, nails are mounted on long strips. Thus, an operator has to find a tool to solve the malfunctioned moveable member. However, it could be time consuming, bothersome and even unsuccessful.

Thus, the need for improvement still exists.

### SUMMARY OF THE INVENTION

It is therefore one object of the invention to provide an adapter for a flooring nail gun, which comprising:

a muzzle member including at least one set of two inclined cavities;

a moveable member including at least one set of two inclined protrusions at an end, the inclined protrusions being disposed in the inclined cavities; and

a quick releasing device disposed on the inclined protrusions;

wherein the quick releasing device comprises a pressing member, a spring member, and a lever; and

wherein the pressing member and the muzzle member are joined, the lever and the pressing member are pivotably secured together, and the spring member has one end anchored at the pressing member and an other end pivotably secured to the lever.

Preferably, the quick releasing device comprises a pressing member, a spring member, and a lever, and wherein the pressing member and the muzzle member are joined, the lever and the pressing member are pivotably secured together, and the spring member has one end anchored at the pressing member and the other end pivotably secured to the lever.

Preferably, the at least one set of two inclined protrusions is one set of two inclined protrusions and the at least one set of two inclined cavities is one set of two inclined cavities.

Preferably, wherein the inclined protrusions are inclined upward , and wherein the inclined cavities are inclined downward.

Preferably, the moveable member further includes a pivot, and wherein the lever including a transverse hole pivotably put on the pivot.

Preferably, the pressing member includes two parallel protuberances, and wherein the moveable member includes two inclined projections at the other end, the inclined projections being engaged the protuberances.

Preferably, the spring member is either a coil spring or a torsion spring.

Preferably, the lever is lower than a top of the moveable member or flush with the top of the moveable member in operation.

Preferably, further comprising an exit formed by both the muzzle member and the moveable member, the exit having a trapezoidal section.

Preferably, the pressing member includes two parallel spaced hooks, and wherein the spring member has one end anchored at the parallel spaced hooks.

By utilizing the invention the following advantages are obtained: The moveable member can be quickly opened in case of malfunction due to complimentary engagement of the moveable member and the muzzle member, the complimentary engagement of the pressing member and the moveable member, and the spring biased lever. Repair time can be decreased greatly. Finally, success can be ensured.

The above and other objects, features and advantages of the invention will become apparent from the following detailed description taken with the accompanying drawings.

### BRIEF DESCRIPTION OF THE DRAWINGS

FIG. 1 is a side elevation in part section of an adapter for a flooring nail gun according to the invention;

FIG. 2 is an exploded view of major components of the adapter;

FIG. 3 is a side elevation showing the adapter in an inoperative position;

FIG. 4 is a view similar to FIG. 3 showing the lever being pivoted counterclockwise to energize a spring in use; and

FIG. 5 is a side elevation of a flooring nail gun with the adapter of the invention mounted thereon.

### DETAILED DESCRIPTION OF THE INVENTION

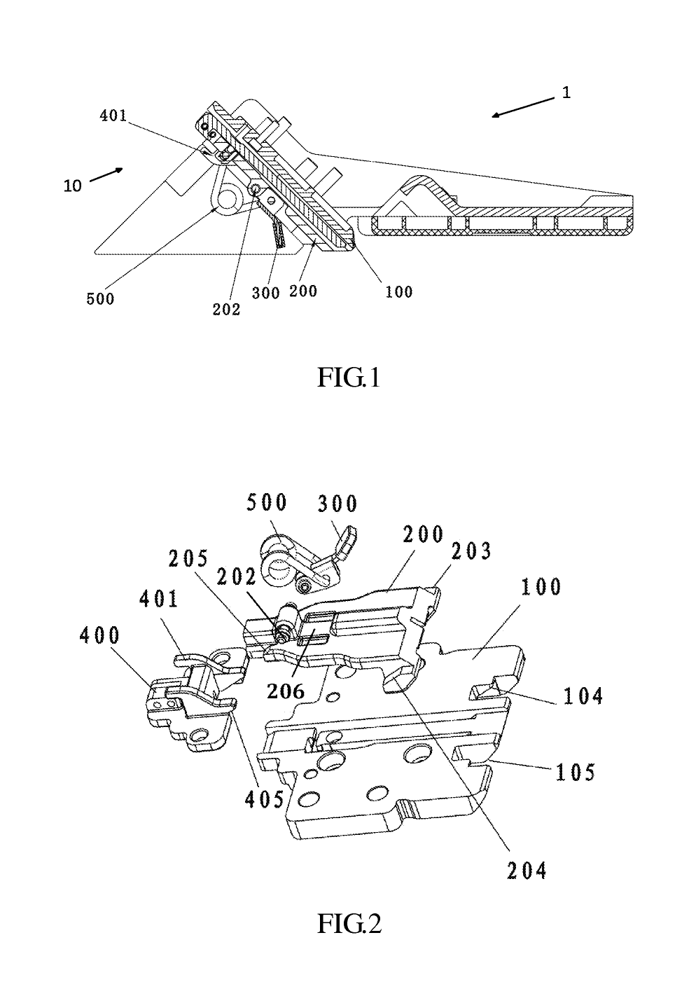

Referring to FIGS. 1 to 5, an adapter 1 for a flooring nail gun 5 in accordance with the invention comprises the following components as discussed in detail below.

A muzzle member 100 and a moveable member 200 are provided. The muzzle member 100 includes two inclined cavities 104, 105 at one edge. The moveable member 200 includes a pivot 202, two inclined protrusions 203, 204 at an end, two inclined projections 205 at the other end, and a recess 206 on an intermediate portion of a top. The cavities 104, 105 are inclined downward. The inclined protrusions 203, 204 are complimentarily disposed in the inclined cavities 104, 105 to join the moveable member 200 and the muzzle member 100.

A quick releasing device 10 of the adapter 1 comprises a pressing member 400 including two parallel spaced hooks 401 and two parallel protuberances 405 opposite to the hooks 401; a spring member (e.g., coil spring or torsion spring) 500 having one end anchored at the hooks 401; and a lever 300 including a transverse hole pivotably put on the pivot 202. The lever 300 is pivotably secured to the other end of the spring member 500 and has a bottom 301 urging against the recess 206 of the moveable member 200. The protuberances 405 are complimentarily engaged the projections 205.

A wood strip 2 is to be secured onto a subfloor 3 by launching nails from the flooring nail gun 5 which has the adapter 1 mounted thereto. An exit 4 of the adapter 1 is formed by both the muzzle member 100 and the moveable member 200 and is in close proximity to the strip 2. It is understood that the exit 4 is required to target an edge of the strip 2. Otherwise, a desired fastening of the strip 2 and the subfloor 3 can be compromised. Thus, the exit 4 has a trapezoidal section and a width as small as possible so as to precisely target an edge of the strip 2.

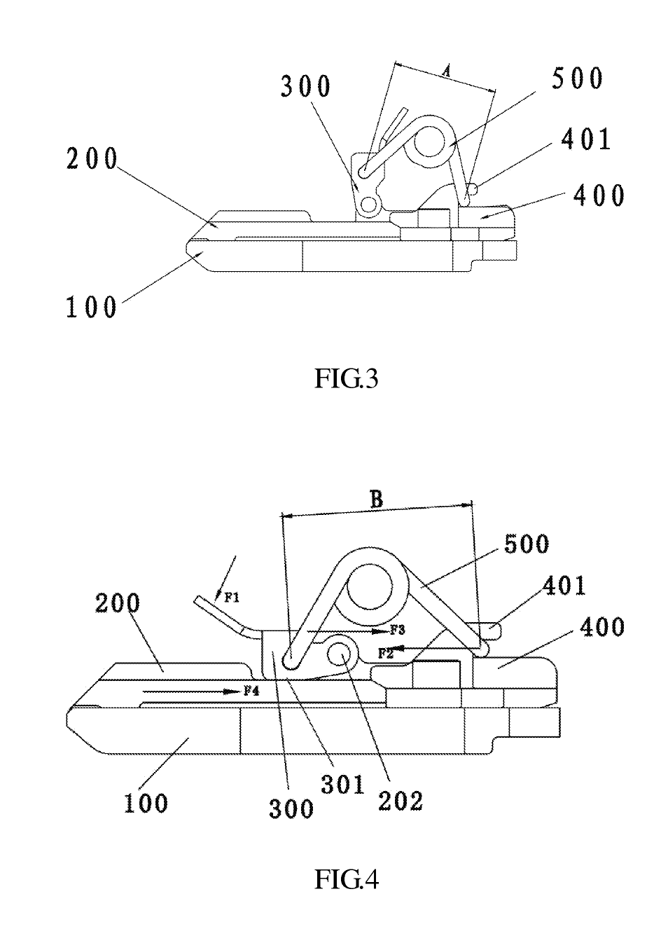

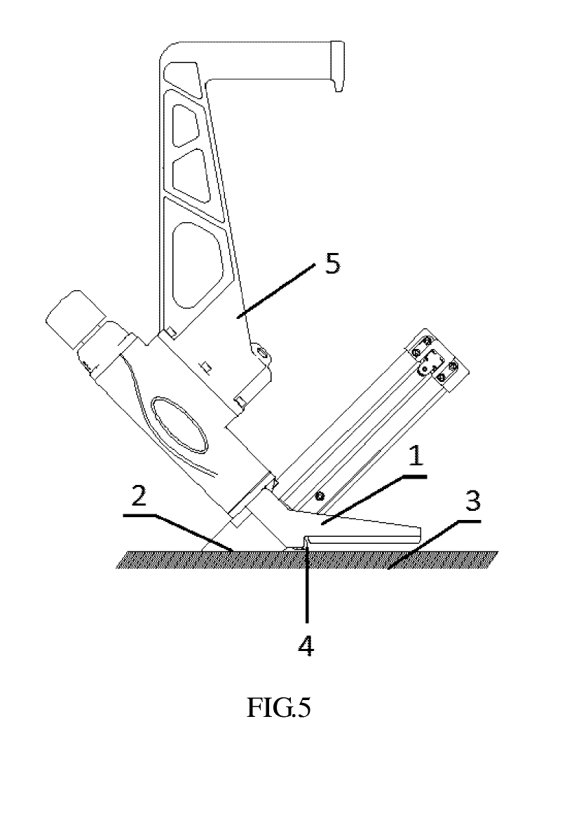

As shown in FIGS. 3 and 4, the spring member 500 is secured to the hooks 401 of the pressing member 400. Alternatively, the spring member 500 is integrally formed with the hooks 401 of the pressing member 400. Still alternatively, the hooks 401 are eliminated and the spring member 500 is integrally formed with the pressing member 400.

In addition to coil spring or torsion spring, the spring member 500 can be another form of spring in other embodiments. Further, the spring member 500 is shaped as V. As shown in FIG. 5, the flooring nail gun 5 stands upright. For preventing the strip 2 from being damaged, the adapter 1 is slightly above the strip 2. Further, the lever 300 is lower than the top of the moveable member 200 or flush with the top of the moveable member 200 in operation.

In case of malfunction, operations of the invention are discussed in detail below (see FIGS. 3 and 4). A distance between both ends of the spring member 500 is designated by A. An operator may clockwise turn the lever 300 (as indicated by arrow F1). Both the pressing member 400 and the muzzle member 100 are fixed. Thus, one end of the spring member 500 may exert a compression force (as indicated by arrow F2) toward the other end thereof. Likewise, the other end of the spring member 500 may exert a compression force (as indicated by arrow F3) toward one end thereof. At this position, the distance between both ends of the spring member 500 is designated by B which is greater than A. Further a force (as indicated by arrow F4) is exerted on the moveable member 200 to move it toward the pressing member 400. A release of the force F1 will return the lever 500 to its inoperative position. At this position, the distance A is equal to the distance B. Thereafter, the operator may open the moveable member 200 of the adapter 1 to solve the problem.

While the invention has been described in terms of preferred embodiments, those skilled in the art will recognize that the invention can be practiced with modifications within the spirit and scope of the appended claims.

What is claimed is:

1. An adapter for a flooring nail gun comprising:
a muzzle member including at least one set of two inclined cavities;
a moveable member including at least one set of two inclined protrusions at an end, the inclined protrusions being disposed in the inclined cavities; and
a quick releasing device disposed on the inclined protrusions;
wherein the quick releasing device comprises a pressing member, a spring member, and a lever; and
wherein the pressing member and the muzzle member are joined, the lever and the pressing member are pivotably secured together, and the spring member has one end anchored at the pressing member and an other end pivotably secured to the lever.

2. The adapter for a flooring nail gun of claim 1, wherein the at least one set of two inclined protrusions is one set of two inclined protrusions and the at least one set of two inclined cavities is one set of two inclined cavities.

3. The adapter for a flooring nail gun of claim 2, wherein the inclined protrusions are inclined upward, and wherein the inclined cavities are inclined downward.

4. The adapter for a flooring nail gun of claim 3, wherein the moveable member further includes a pivot, and wherein the lever including a transverse hole pivotably put on the pivot.

5. The adapter for a flooring nail gun of claim 1, wherein the pressing member includes two parallel protuberances, and wherein the moveable member includes two inclined projections at an other end, the inclined projections being engaged the protuberances.

6. The adapter for a flooring nail gun of claim 1, wherein the spring member is a coil spring.

7. The adapter for a flooring nail gun of claim 1, wherein the spring member is a torsion spring.

8. The adapter for a flooring nail gun of claim 1, wherein the lever is lower than a top of the moveable member or flush with the top of the moveable member in operation.

9. The adapter for a flooring nail gun of claim 1, further comprising an exit formed by both the muzzle member and the moveable member, the exit having a trapezoidal section.

10. The adapter for a flooring nail gun of claim 1, wherein the pressing member includes two parallel spaced hooks, and wherein the spring member has one end anchored at the parallel spaced hooks.
